(19) United States
(12) Patent Application Publication
(10) Pub. No.: US 2003/0182094 A1
(43) Pub. Date: Sep. 25, 2003

(54) Methods for classifying and searching chemical reactions

(76) Inventors: Howard Barff Broughton, Madrid (ES); Peter Alan Hunt, Saffron Walden (GB); Mark Denis MacKey, Stanstead (GB)

Correspondence Address: MERCK AND CO INC, P O BOX 2000, RAHWAY, NJ, 070650907

(21) Appl. No.: 10/367,550

(22) Filed: Feb. 14, 2003

(30) Foreign Application Priority Data
Feb. 14, 2002 (GB) 0203542.6

(51) Int. Cl. G06G 7/48; G06G 7/58

(52) U.S. Cl. 703/11; 703/12

(57) ABSTRACT

There is disclosed a method of characterising a chemical reaction, in terms of the structural changes occurring thereby, by means of a reaction vector value. The method may be used to identify and quantify objective similarities among members of a selected group of reactions, or between a probe reaction and members of a selected group of reactions.

This invention lies in the field of data processing, in particular the storage, retrieval and manipulation of data pertaining to chemical reactions. Specifically, the invention provides methods and apparatus for the objective classification of chemical reactions in terms of the structural changes occurring thereby, and searching and comparison methods employing same.

It is well known in the art to generate computer-readable databases containing data pertaining to molecular structures, and to search or sort such data in accordance with preselected criteria. For example, it is possible to search for a target compound within the database or, more generally, to select compounds in the database which share a particular substructure.

Similarity searching of chemical structures is also known, whereby chemical structures in a database are ranked by degree of similarity to a target structure or substructure—see, for example, Carhart et al, J. Chem. Inf. Comput. Sci., 25, 64-73, 1985; Downs and Willett, “Similarity Searching in Databases of Chemical Structures”, in Reviews in Computational Chemistry: Volume 7 (eds Lipkowitz and Boyd), 1-65, VCH, New York 1996; Kearsley et al, J. Chem. Inf Comput. Sci., 36, 118-127, 1996); and Willett, J. Chem. Inf. Comput. Sci., 38, 983-996, 1998. Commercially-available examples of such systems include those available from Daylight Chemical Information Systems Inc., Mission Vieja, Calif., and their underlying theory is explained in the Daylight Theory Manual which is viewable at http://www.daylight.com.

It is also known to store and manipulate data pertaining to chemical reactions in which one or more reactants are transformed into one or more products. Various criteria have been used to index such data and attempts made to apply similarity searching to the indexed data (see, for example, Section 7 of the above-referenced Daylight Theory Manual, and articles such as Moock et al, Tetrahedron Computer Methodology, 1, 117-128, 1988; Bador, New J. Chem., 16, 413-23, 1992; Gasteiger et al, J. Chem. Inf Comput. Sci., 32, 700-712, 1992; and Hendrickson et al, J. Chem. Inf Comput. Sci., 35, 251-260, 1995.

At a simple level, the data defining a reaction may be merely the aggregate of the data defining its products and reactants. However, such a classification system does not encode any information regarding the actual chemical processes involved (e.g. which bonds are broken or formed), and hence cannot be used to search for similarities between reactions. The resulting databases must be searched explicitly, with the user specifying a molecular subgraph (or set of subgraphs divided into reagents and products) on which to search, and the search being performed by explicitly matching that subgraph. The search will only return exact matches to the structures entered as queries, and hence over-strict queries may fail to find any matches while over-broad queries may find many thousands. Furthermore, many chemical reaction databases have large amounts of poor-quality data, and in many cases a search will fail because a reagent which is searched for explicitly as part of a reaction scheme is not included as a reactant in the relevant entry in the database.

More sophisticated classification systems have therefore been developed which record, as a bitstring, the bond changes occurring in a reaction (see, for example, Hendrickson and Miller, J. Chem. Inf Comput. Sci., 30, 403-408, 1990; and Section 7.7.2 of the Daylight Theory Manual). In order to generate such a bitstring, it is preferable to start with a fully balanced stoichiometric equation and to generate a mapping of the reagent atoms on to the product atoms. Such a mapping can be generated by the user (which is laborious) or by computer (in which case poor mappings can lead to failure of the search). Furthermore, the resulting fingerprint may not always distinguish between the forward and backward directions of a reversible reaction.

The present invention provides a novel method of classifying chemical reactions which avoids these disadvantages.

The invention provides a method of characterising, in terms of the structural changes occurring thereby, a chemical reaction in which one or more reactants are transformed into one or more products, said method comprising the steps of:

(i) recording for each of the reactants of said reaction the value in vector form of one or more sets of structural descriptors, and summing the vectors thus obtained to provide a reactant vector sum;

(ii) recording for each of the products of said reaction the value in vector form of the identical set or sets of structural descriptors, and summing the vectors thus obtained to provide a products vector sum; and

(iii) subtracting the products vector sum from the reactants vector sum to provide a reaction vector value characteristic of the said reaction.

The above-defined method provides a vector value which characterises a given reaction in terms of the structural changes taking place as a result of that reaction. In contrast to the methods used in the prior art, it is not necessary to start with a balanced stoichiometric equation, and no mapping of reactant atoms to product atoms is involved. The reaction vector values obtained in accordance with the invention are particularly useful for identifying objective similarities among a group of reactions, or between members of that group and a reference or probe reaction.

Accordingly, the invention further provides a method of identifying and quantifying objective similarities among members of a selected group of chemical reactions comprising the steps of:

(a) for each reaction in the group, calculating a reaction vector value by the method defined above;

(b) calculating a numerical measure of the similarity between the reaction vectors obtained in step (a) for all possible combinations of two reactions selected from the group; and

(c) performing a cluster analysis of the results obtained in step (b).

The invention also provides a method of identifying and quantifying objective similarities between a probe reaction and members of a selected group of chemical reactions comprising the steps of:

(a) for the probe reaction and for each reaction in the group, calculating a reaction vector value by the method defined above;

(b) comparing the reaction vector value of the probe reaction with the reaction vector value of each of the chemical reactions in the group and calculating a numerical measure of the similarity therebetween; and

(c) from the results obtained in step (b), identifying the reaction(s) in the group having the greatest objective similarity to the probe reaction.

The structural descriptors in steps (i) and (ii) of the characterising method of the invention may include any of the topological descriptors known in the art for use in encoding chemical structures for storage and searching in computer databases, including those disclosed in Section 4 of “Chemical Similarity Searching”, Willett et al, J. Chem. Inf. Comput. Sci., 38, 983-96, 1998. These include algorithmically-generated descriptors such as atom pairs (APs), topological torsions (TTs), atom triplets, and generalised physicochemical property-based variants of these. Further details of the theory and application of these descriptors may be found in J. Chem. Inf. Comput. Sci., 25, 64, 1985 (APs); J. Chem. Inf. Comput. Sci., 27, 82, 1987 (TTs); and J. Chem. Inf. Comput. Sci., 36, 128, 1996 (variants of these).

The choice of descriptor may depend on the type of information the user wishes to encode. For example, use of topological torsion counts as the descriptor leads to the encoding of information predominantly concerning the local environment of the reaction centre, since parts of reagents which are topologically distant from the reaction centre will contribute identical descriptors in both the reactants and the products, and hence will make no net contribution to the reaction vector. On the other hand, using topological atom pairs as the parameter leads to the encoding of information about the total molecular environment of the reaction. As explained below, it is useful to calculate, for a given reaction, separate reaction vector values using different topological parameters.

Whichever descriptor is selected, its value is recorded in vector form for each of the reactants and each of the products of a given reaction. The elements of the vector are the value of the descriptor (for descriptors related to a continuous property), the count of how many times the descriptor is present in the molecule, or a binary presence or absence flag for the descriptor. By summing the resulting vectors in respect of all the reactants, and summing the vectors in respect of all the products, then subtracting the latter sum from the former, the overall reaction vector value is obtained.

In order to identify and/or quantify objective similarities among a group of reactions, or between a probe reaction and members of a group of reactions, it is necessary to calculate a numerical measure of the similarities between their individual reaction vector values. A variety of numerical measures may be used for this purpose, including those used in the art for assessing similarities between molecules (see, for example, Section 2 of the above-referenced article by Willett et al). These include Tanamoto coefficients, Euclidean distances and cosine coefficients. Of these, the most preferred is the cosine correlation coefficient. This gives values ranging continuously from +1 (indicating an exact match) through zero (no correlation) to −1 (exact match, but reaction proceeding in the reverse direction). Furthermore, a plot of the cosine function is S-shaped, and its gradient is steepest as it passes through zero. Hence, its discriminating power is greatest in the region of zero, i.e. where the levels of similarity between reactions are low.

Having obtained the relevant numerical measures of similarity, conventional methods of data analysis may be used to cluster reactions according to their degree of mutual similarity, or to identify the reactions most closely matching a probe reaction, e.g. by ranking a group of reactions in order of their similarity to the probe reaction.

The results obtained may be of practical benefit in a variety of areas. For example, the techniques may be used to identify correlations between biological and non-biological chemical processes, or within groups of biological processes. Where a probe reaction is compared with a collection of reactions, said probe reaction may be a known transformation for which alternative conditions are sought, or may be a hypothetical transformation for which analogues are sought. If a reactant and a product of a probe reaction both share a desirable property (e.g. a biological activity), carrying out the comparison in accordance with the invention can lead to the identification of new synthetic targets predicted to have the same desirable property.

In a particular embodiment of the invention, two or more sets of reaction vector values, derived from different selections of structural descriptor, are calculated for the reactions being compared, and numerical measures of the similarities between reaction vector values are calculated for each set, so that for any pair of reactions being compared there exists two or more numerical measures of objective similarity. Subsequent clustering, selection and/or ordering operations are then carried out on the basis of an optionally weighted average of the said two or more numerical measures of similarity. This enables searching and/or sorting to be performed in accordance with more accurately tailored criteria. For example, by combining similarity measures reflecting atom pair similarity with similarity measures reflecting topological torsion similarity, it is possible to continuously vary the emphasis of a searching or sorting operation between the local environment of the reaction centre and the overall molecular environment. Combinations of APs and TTs, weighted in the range 3:1 to 1:3 have been found to be particularly effective.

The methods of the invention may be readily implemented using conventional digital computer technology and software.

Therefore, the invention also provides a computer programme (or a data storage device containing a computer programme) which, when installed in a digital computer, enables said computer to execute a method of classifying chemical reactions, or a method of identifying and quantifying objective similarities among members of a selected group of chemical reactions, or a method of identifying and quantifying objective similarities between a probe reaction and members of a selected group of chemical reactions, as defined previously.

The invention further extends to a digital computer which is programmed to execute a method of classifying chemical reactions, or a method of identifying and quantifying objective similarities among members of a selected group of chemical reactions, or a method of identifying and quantifying objective similarities between a probe reaction and members of a selected group of chemical reactions, as defined previously.

The invention also provides a data storage device having stored therein data pertaining to a plurality of chemical reactions, said data comprising, in respect of each one of said chemical reactions, at least one reaction vector value calculated by the method defined previously.

Data storage devices useful in the practice of the invention include conventional computer-readable devices such as hard magnetic discs, floppy magnetic discs, magnetic tape, optical discs and magnetooptical discs.

### EXAMPLES

The indexing and searching methods of the invention were compared with the Daylight™ V.4.72 software (commercially available from Daylight Chemical Information Systems Inc., Mission Viejo, Calif.) for their performance in selecting reactions from a database and ranking them in order of similarity to a target reaction. The comparison was carried out for the following four separate target reactions, involving diverse chemical transformations:

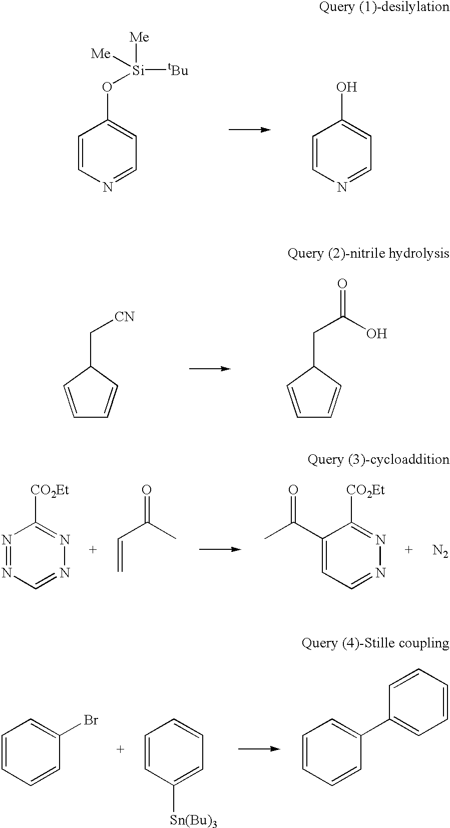

For the purpose of the comparison, a test database of 550 reactions was compiled from several commercial databases using the ISIS browser, selected so that the test database contained a reasonable number of potential hits for each of the query reactions. Each reaction in the test database was examined independently by three observers, and registered as either similar or not similar to each of the query reactions. In this way, two hit sets were compiled for each query, namely a total hit set (THS) consisting of all the reactions identified by at least one observer as being similar to the relevant query reaction, and a consensus hit set (CHS) restricted to those reactions identified by all three observers as being similar to the relevant query reaction (queries (1) and (2)), or by two or more observers (queries (3) and (4)).

The contents of the database were ranked in order of similarity to each of the query reactions, using both the Daylight™ software and the method of the invention. For the Daylight™ searches, rankings according to both Tanimoto similarity and Euclidean distance were obtained, but the former consistently gave the better performance, and so only those results are quoted here. Searches in accordance with the inventive method employed a combination of APs and TTs with three different relative weightings, namely 1:3, 1:1 and 3:1, with the results ranked according to cosine coefficient.

For the top 30 rankings in each search, the recall and precision were calculated as follows:

recall=(no. of hits retrieved)/(no. of hits available in database)

precision=(no. of hits retrieved)/(no. of reactions retrieved)

In principle, both parameters can vary continuously from 0 to 1, but when the sample size (30) is less than the size of the hit set, the maximum recall attainable will be less than 1. Conversely, when the sample size is greater than the size of the hit set, the maximum precision attainable will be less than 1.

The results for the four queries are as follows.

Query (1)
THS - 27 reactions; CHS - 17 reactions

| | No. of Hits | | Recall | | Precision | |
|---|---|---|---|---|---|---|
| Search | THS | CHS | THS | CHS | THS | CHS* |
| Daylight ™ | 20 | 15 | 0.74 | 0.88 | 0.67 | 0.50 |
| Invention | 23 | 17 | 0.85 | 1.00 | 0.77 | 0.57 |
| (AP1 + TT3) | | | | | | |
| Invention | 24 | 17 | 0.89 | 1.00 | 0.80 | 0.57 |
| (AP1 + TT1) | | | | | | |
| Invention | 24 | 16 | 0.89 | 0.94 | 0.80 | 0.53 |
| (AP3 + TT1) | | | | | | |

*maximum possible value = 17/30 = 0.57

Query (2)
THS - 41 reactions; CHS - 22 reactions

| | No. of Hits | | Recall | | Precision | |
|---|---|---|---|---|---|---|
| Search | THS | CHS | THS** | CHS | THS | CHS* |
| Daylight ™ | 14 | 10 | 0.34 | 0.45 | 0.47 | 0.33 |
| Invention | 13 | 10 | 0.32 | 0.45 | 0.43 | 0.33 |
| (AP1 + TT3) | | | | | | |
| Invention | 14 | 11 | 0.34 | 0.50 | 0.47 | 0.37 |
| (AP1 + TT1) | | | | | | |
| Invention | 13 | 10 | 0.32 | 0.45 | 0.43 | 0.33 |
| (AP3 + TT1) | | | | | | |

*maximum possible value = 22/30 = 0.73
**maximum possible value = 30/47 = 0.64

Query (3)
THS - 87 reactions; CHS - 31 reactions

| | No. of Hits | | Recall | | Precision | |
|---|---|---|---|---|---|---|
| Search | THS | CHS | THS** | CHS | THS | CHS |
| Daylight ™ | 6 | 4 | 0.07 | 0.19 | 0.20 | 0.13 |
| Invention | 26 | 15 | 0.30 | 0.48 | 0.87 | 0.50 |
| (AP1 + TT3) | | | | | | |
| Invention | 25 | 15 | 0.28 | 0.48 | 0.83 | 0.50 |
| (AP1 + TT1) | | | | | | |
| Invention | 24 | 13 | 0.27 | 0.42 | 0.80 | 0.43 |
| (AP3 + TT1) | | | | | | |

**maximum possible value = 30/87 = 0.34

Query (4)
THS - 100 reactions; CHS - 38 reactions

| | No. of Hits | | Recall | | Precision | |
|---|---|---|---|---|---|---|
| Search | THS | CHS | THS** | CHS | THS | CHS |
| Daylight ™ | 25 | 12 | 0.25 | 0.32 | 0.83 | 0.4 |
| Invention | 27 | 20 | 0.27 | 0.53 | 0.90 | 0.67 |
| (AP1 + TT3) | | | | | | |
| Invention | 27 | 20 | 0.27 | 0.53 | 0.90 | 0.67 |
| (AP1 + TT1) | | | | | | |
| Invention | 27 | 19 | 0.27 | 0.50 | 0.90 | 0.63 |
| (AP3 + TT1) | | | | | | |

**maximum possible value = 30/100 = 0.30

Thus, for all four queries, one or more of the embodiments of the invention out-performed the method of the prior art.

1. A method of characterising, in terms of the structural changes occurring thereby, a chemical reaction in which one or more reactants are transformed into one or more products, said method comprising the steps of:
(i) recording for each of the reactants of said reaction the value in vector form of one or more sets of structural descriptors, and summing the vectors thus obtained to provide a reactant vector sum;
(ii) recording for each of the products of said reaction the value in vector form of the identical set or sets of structural descriptors, and summing the vectors thus obtained to provide a products vector sum; and
(iii) subtracting the products vector sum from the reactants vector sum to provide a reaction vector value characteristic of the said reaction.

2. The method of claim 1 wherein the structural descriptors are selected from the group consisting of atom pairs, topological torsions and atom triplets.

3. A method of identifying and quantifying objective similarities among members of a selected group of chemical reactions comprising the steps of:
(a) for each reaction in the group, calculating a reaction vector value by the method of claim 1;
(b) calculating a numerical measure of the similarity between the reaction vectors obtained in step (a) for all possible combinations of two reactions selected from the group; and
(c) performing a cluster analysis of the results obtained in step (b).

4. The method of claim 3 wherein the reaction vector value in step (a) is calculated using structural descriptors selected from the group consisting of atom pairs, topological torsions and atom triplets.

5. The method of claim 3 wherein the numerical measure of similarity calculated in step (b) is the cosine coefficient.

6. The method of claim 4 wherein the numerical measure of similarity calculated in step (b) is the cosine coefficient.

7. A method of identifying and quantifying objective similarities between a probe reaction and members of a selected group of chemical reactions comprising the steps of:
(a) for the probe reaction and for each reaction in the group, calculating a reaction vector value by the method of claim 1;
(b) comparing the reaction vector value of the probe reaction with the reaction vector value of each of the chemical reactions in the group and calculating a numerical measure of the similarity therebetween; and
(c) from the results obtained in step (b), identifying the reaction(s) in the group having the greatest objective similarity to the probe reaction.

8. The method of claim 7 wherein the reaction vector value in step (a) is calculated using structural descriptors selected from the group consisting of atom pairs, topological torsions and atom triplets.

9. The method of claim 7 wherein the numerical measure of similarity calculated in step (b) is the cosine coefficient.

10. The method of claim 8 wherein the numerical measure of similarity calculated in step (b) is the cosine coefficient.

11. The method of claim 7 wherein step (c) comprises ranking the reactions in the group in the order of their similarity to the probe reaction.

12. A method according to claim 3 wherein two or more sets of reaction vector values, corresponding to different selections of structural descriptor, are calculated for the group of reactions being compared, and numerical measures of the similarities between reaction vector values are calculated for each set, so that for any pair of reactions being compared there exists two or more numerical measures of objective similarity, wherein subsequent clustering analysis is carried out on the basis of an optionally weighted average of the said two or more numerical measures of similarity.

13. A method according to claim 12 wherein two sets of reaction vector values, derived from the selection of atom pairs and topological torsions as structural descriptors, are calculated for the reactions being compared, and numerical measures of the similarities between reaction vector values are calculated for each set, so that for any pair of reactions being compared there exists two numerical measures of objective similarity, wherein subsequent clustering analysis is carried out on the basis of an average of the said two numerical measures of similarity which is weighted in the range 3:1 to 1:3.

14. A method according to claim 7 wherein two or more sets of reaction vector values, corresponding to different selections of structural descriptor, are calculated for the reactions being compared, and numerical measures of the similarities between reaction vector values are calculated for each set, so that for any pair of reactions being compared there exists two or more numerical measures of objective similarity, wherein subsequent selection and/or ordering operations are carried out on the basis of an optionally weighted average of the said two or more numerical measures of similarity.

15. A method according to claim 14 wherein two sets of reaction vector values, derived from the selection of atom pairs and topological torsions as structural descriptors, are calculated for the reactions being compared, and numerical measures of the similarities between reaction vector values are calculated for each set, so that for any pair of reactions being compared there exists two numerical measures of objective similarity, wherein subsequent selection and/or ordering operations are carried out on the basis of an average of the said two numerical measures of similarity which is weighted in the range 3:1 to 1:3.

16. A computer programme which, when installed in a digital computer, enables said computer to execute a method of characterising chemical reactions as defined in claim 1.

17. A computer programme which, when installed in a digital computer, enables said computer to execute a method of identifying and quantifying objective similarities among members of a selected group of chemical reactions as defined in claim 3.

18. A computer programme which, when installed in a digital computer, enables said computer to execute a method of identifying and quantifying objective similarities between a probe reaction and members of a selected group of chemical reactions, as defined in claim 7.

19. A data storage device having stored therein data pertaining to a plurality of chemical reactions, said data comprising, in respect of each one of said chemical reactions, at least one reaction vector value calculated by the method defined in claim 1.
